(19) United States
(12) Patent Application Publication
(10) Pub. No.: US 2018/0092029 A1
(43) Pub. Date: Mar. 29, 2018

(54) EXTENDED NEIGHBOR LIST AND OPTIMIZED ACCESS POINT DISCOVERY

(71) Applicant: Intel IP Corporation, Santa Clara, CA (US)

(72) Inventors: NECATI CANPOLAT, Beaverton, OR (US); VIVEK GUPTA, SAN JOSE, CA (US); VENKATA R. VALLABHU, PORTLAND, OR (US)

(21) Appl. No.: 15/278,905

(22) Filed: Sep. 28, 2016

(51) Int. Cl. H04W 48/16; H04W 24/02

(52) U.S. Cl. CPC H04W 48/16; H04W 24/02

(57) ABSTRACT

This disclosure describes systems, methods, and apparatus related to an extended neighbor list and optimized AP and wireless networks discovery. A device may cause to perform a scan across one or more frequency bands. The device may determine one or more access devices based at least in part on the scan. The device may generate an extended neighbor list (ENL) associated with the one or more access devices. The device may cause to send the ENL to one or more first devices.

### TECHNICAL FIELD

This disclosure generally relates to systems and methods for wireless communications and, more particularly, to extended neighbor list and optimized access point (AP) discovery.

### BACKGROUND

Wireless devices are becoming widely prevalent and are increasingly requesting access to wireless channels. The wireless devices with Wi-Fi capabilities and other similar capabilities in unlicensed bands continuously scan available frequency bands in order to find access points (APs) to connect to. However, as the number of these wireless devices and networks increases, additional messaging may affect the available bandwidth and may result in decreased user experience.

### BRIEF DESCRIPTION OF THE DRAWINGS

FIG. 1 depicts a diagram illustrating an example network environment of an illustrative extended neighbor list and optimized AP discovery system, according to one or more example embodiments of the disclosure.

FIG. 2 depicts an illustrative schematic diagram of an extended neighbor list and optimized AP discovery system, in accordance with one or more example embodiments of the present disclosure.

FIG. 3 depicts illustrative frame formats associated with an extended neighbor list and optimized AP discovery, in accordance with one or more example embodiments of the present disclosure.

FIG. 4 depicts a flow diagram of an illustrative process for an illustrative extended neighbor list and optimized AP discovery system, in accordance with one or more example embodiments of the present disclosure.

FIG. 5 depicts a flow diagram of an illustrative process for an illustrative extended neighbor list and optimized AP discovery system, in accordance with one or more example embodiments of the present disclosure.

FIG. 6 illustrates a functional diagram of an example communication station that may be suitable for use as a user device, in accordance with one or more example embodiments of the present disclosure.

FIG. 7 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices for providing signaling to Wi-Fi devices in various Wi-Fi networks.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

During communication between two devices, one or more frames may be sent and received. These frames may include one or more fields (or symbols) that may be based on an IEEE 802.11 standard.

Typically, the IEEE 802.11 standard has defined neighbor report or reduced neighbor report mechanisms, which only provide the list of APs that belong to the same extended service set (ESS). The ESS is a set of one or more interconnected basic service sets (BSSs) and integrated local area networks (LANs) that appears as a single BSS to the logical link control layer at any station associated with one of those BSSs. An independent BSS (IBSS) includes no APs. A BSS that includes at least one AP is referred to as an infrastructure BSS. A set of one or more infrastructure BSSs that appear as a single BSS is an ESS. An ESS is the union of the infrastructure BSSs with the same service set identifier (SSID) connected by a distributed system (DS). The DS is the architectural component used to interconnect infrastructure BSSs. Data moves between a BSS and the DS via an AP. Note that all APs are also stations (STAs); thus, they are addressable entities. The ESS networks may be physically present in the same location and may overlap with other ESS networks set up by different organizations (e.g., network operators, network carriers, or wireless companies). Each ESS has an ID called the service set identifier (SSID). The SSID is also referred to as the network name. An SSID is primarily designed to distinguish a wireless local area network in locations where other WLANs might also be broadcasting simultaneously. The SSID is used to group and identify the ESS so that a new device connecting to this network can easily identify and connect to it. For example, all APs and STAs specify the correct SSID of their ESS in order to authenticate and gain network connectivity.

The reduced neighbor report provides the band, the operating channel, the short SSID, and the target beacon transmission time (TBTT) information header for each AP belonging to the same ESS, which limits its usage substantially. However, due to the increased density deployments, where multiple ESSs overlap, soft APs and/or mobile devices and ad hoc networks are commonly enabled and Wi-Fi networks are increasing everywhere. Hence, the 802.11 neighbor report or reduced neighbor report is not capable of addressing the new evolution in this space.

Example embodiments of the present disclosure relate to systems, methods, and devices for extended neighbor list and optimized AP discovery and is applicable to other similar technologies in unlicensed bands and shared spectrum as well.

Optimized connectivity experience (OCE) is an initiative at Wi-Fi Alliance (WFA) to provide a better user experience in managed network environments with a high density of active or connected devices. In one embodiment, OCE may enhance and improve the Wi-Fi experience by minimizing control and management frames in order to provide more bandwidth for data frames during Wi-Fi communications.

One of the fundamental tasks for a Wi-Fi mobile device (STA) is to find the Wi-Fi access points to connect to. Wi-Fi mobile devices (STAs) discover the available APs by continuously scanning all available bands and channels in 2.4 GHz, 3.5 GHz, 5 GHz, 60 GHz and future available bands and all channels within them so that the device can find the best AP/network to connect to taking into account variety of factors such as cost, QoS of network and other such metrics.

A scan may be performed actively or passively. In the active scan, STAs tune into a particular band and a channel and send probe requests either with a specific destination SSID or broadcast SSID and then they wait for probe responses or periodic beacons from the APs on that channel. The STAs have to go through all channels in each band. The STAs typically wait about 10 milliseconds (ms) per channel. In the passive scan, STAs tune into the band and channel and wait for a periodic beacon from the APs on that channel. By default, the APs send beacons every 100 ms. Since it may take 100 ms to hear the periodic beacons, most devices prefer to use an active scan.

The process of performing a scan may cause a number of issues in the network. For example, scanning all the bands and channels is a time consuming process and causes a delay for the STAs to find the best AP/network quickly. Scanning all bands and channels may also cause the STAs to consume a significant amount of power in this process resulting in reduced battery life with Wi-Fi. Further, during the scanning process, the STAs typically send active probe requests and receive probe responses to discover the APs/networks around them. This process creates substantial airspace thrashing where, especially in high density areas, up to 70% of the available band is used up with this type of management frame, leaving only a limited space for actual data transmission and resulting in poor user experience with Wi-Fi.

In one embodiment, an extended neighbor list and optimized AP discovery system may enable providing a complete list of APs and wireless networks across all the bands and channels in the neighborhood so that the STAs can make use of such information when prioritizing their channels for scanning and helping with fast discovery and association with the best AP/network.

In one embodiment, the extended neighbor list and optimized AP discovery system may facilitate mobile devices to quickly find the best APs and/or networks to connect to. The benefits may be reduced power consumption, reduced delay, and minimized airspace thrashing due to the increased number of probe requests and response messages.

In one embodiment, the extended neighbor list and optimized AP discovery system may enable APs to scan all the bands (e.g., 2.4 GHz, 3.5 GHz, 5 GHz, 60 GHz, and any other future bands) they support and all channels within the bands regardless of whether the APs belong to the same ESS or not.

In one embodiment, the extended neighbor list and optimized AP discovery system may build an extended neighbor list (ENL) of all APs—including the APs belonging to particular ESSs and other APs from different ESSs, standalone APs (BSSs), software APs (soft APs), and Wi-Fi direct group owner (GO) devices.

In one embodiment, the extended neighbor list and optimized AP discovery system may enable an AP to indicate the presence of the ENL and transmit it to the nearby mobile devices (STAs). These STAs may receive the ENL in order to minimize having to continuously scan available frequency bands in order to find APs to connect to.

In one embodiment, the extended neighbor list and optimized AP discovery system may enable the STAs to use the ENL to prioritize scanning of the channels and APs quickly and to associate with the correct AP/network without going through a full scan of bands and channels.

The above descriptions are for purposes of illustration and are not meant to be limiting to Wi-Fi as they could be applicable to other unlicensed solutions such as MultiFire. Numerous other examples, configurations, processes, etc., may exist, some of which are described in detail below. Example embodiments will now be described with reference to the accompanying figures.

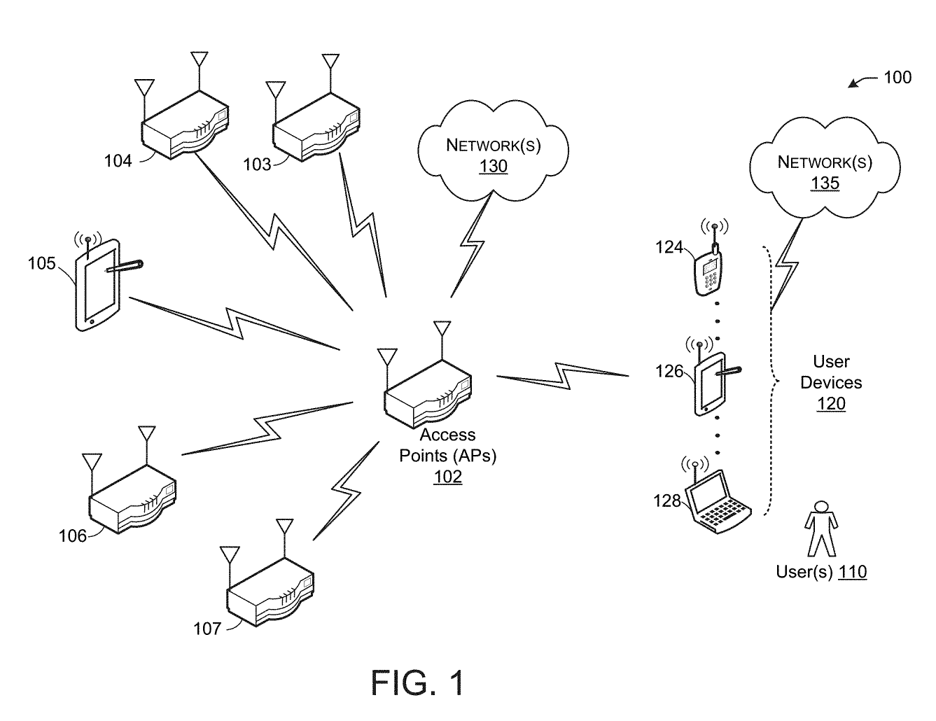

FIG. 1 is a diagram illustrating an example network environment, according to some example embodiments of the present disclosure. Wireless network 100 may include one or more user devices 120 and one or more access point(s) (APs) 102 (including APs 103, 104, 105, 106 and 107), which may communicate in accordance with IEEE 802.11 communication standards. The user device(s) 120 may be mobile devices that are non-stationary and do not have fixed locations.

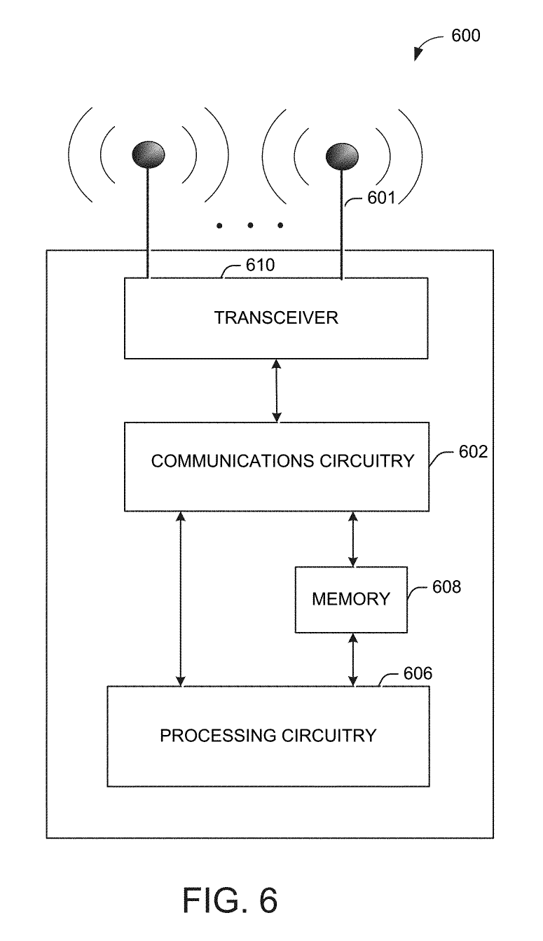

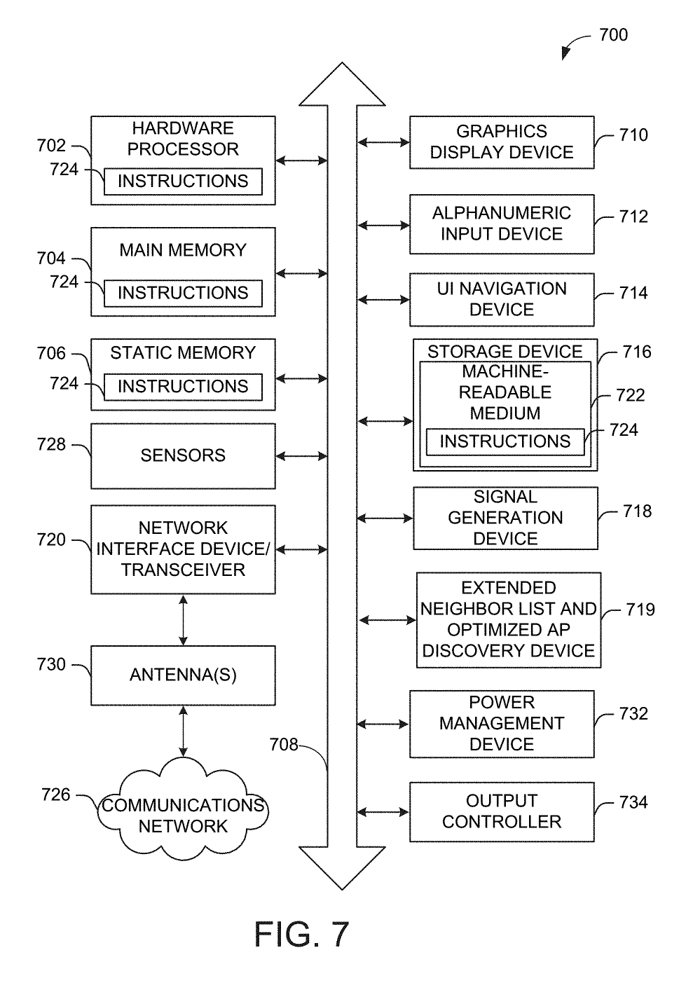

In some embodiments, the user devices 120 and AP(s) 102 may include one or more computer systems similar to that of the functional diagram of FIG. 6 and/or the example machine/system of FIG. 7.

One or more illustrative user device(s) 120 and/or AP(s) 102 (including APs 103, 104, 105, 106, and 107) may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The user device(s) 120 (e.g., 124, 126, or 128) and/or AP(s) 102 (including APs 103, 104, 105, 106 and 107) may include any suitable processor-driven device including, but not limited to, a mobile device or a non-mobile, e.g., a static, device. For example, user device(s) 120 and/or AP(s) 102 (including APs 103, 104, 105, 106, and 107) may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices such as lamps, climate control, car components, household components, appliances, etc. may also be included in this list.

Any of the user device(s) 120 (e.g., user devices 124, 126, 128), and AP(s) 102 (including APs 103, 104, 105, 106, and 107) may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP(s) 102 (including APs 103, 104, 105, 106, and 107) may include one or more communications antennas. The one or more communications antennas may be any suitable type of antennas corresponding to the communications protocols used by the user device(s) 120 (e.g., user devices 124, 126 and 128), and AP(s) 102 (including APs 103, 104, 105, 106, and 107). Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102. This preferably may include all similar technologies operating in unlicensed bands such as MultiFire and others (e.g., 3.5 GHz citizens broadband radio service (CBRS) neutral host). CBRS is considered a “neutral-host solution” for its ability to front end multiple carriers using the common 3.5 GHz spectrum.

Any of the user device(s) 120 (e.g., user devices 124, 126, 128), and AP(s) 102 (including APs 103, 104, 105, 106, and 107) may be configured to perform directional transmission and/or directional reception in conjunction with wirelessly communicating in a wireless network. Any of the user device(s) 120 (e.g., user devices 124, 126, 128), and AP(s) 102 (including APs 103, 104, 105, 106, and 107) may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 (including APs 103, 104, 105, 106, and 107) may be configured to perform any given directional transmission towards one or more defined transmit sectors. Any of the user device(s) 120 (e.g., user devices 124, 126, 128), and AP(s) 102 (including APs 103, 104, 105, 106, and 107) may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP(s) 102 (including APs 103, 104, 105, 106, and 107) may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards, including in part IEEE 802.11ai. In certain example embodiments, the radio component, in cooperation with the communications antennas, may be configured to communicate via 2.4 GHz channels (e.g. 802.11b, 802.11g, 802.11n, 802.11ax, 802.11ai, or other standards), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124, 126, and/or 128), the AP 102 may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices).

Referring to FIG. 1, one or more user devices 120 may attempt to connect to at least one AP (e.g., AP 102).

In one embodiment, an extended neighbor list and optimized AP discovery may provide mechanisms for APs to discover all neighbor APs across all the bands (e.g., 2.4, 3.5 GHz, 5 GHz, 60 GHz, or any other bands) and channels they support, build a full list of APs with the APs' information, and transmit it to the user device.

In one embodiment, one or more APs may periodically scan and detect all other neighbor APs across all the bands and channels they support. For example, the AP 102 may perform a scan in order to discover all neighbor APs (e.g., APs 103, 104, 105, 106, and 107). A scan may be performed by utilizing discovery techniques, such as active scanning, passive scanning, out of band configuration, fast initial link set up (FILS) discovery frames, access network query protocol (ANQP) queries, and other methods across all the bands and channels supported by the one or more APs or neutral host devices in unlicensed or shared spectrum such as 3.5 GHz.

In one embodiment, the APs or neutral host devices may build the extended neighbor list by including at least one of a band, an operating channel, a short SSID (or SSID), or a TBTT for each AP within the same ESS, APs belonging to different ESSs, a standalone BSS, a soft AP, or a Wi-Fi direct GO device. The APs may signal the presence/availability of the ENL to the user devices 120 in the vicinity by setting the appropriate bit for the ENL and also including the ENL in beacons, probe responses, and FILS discovery frames and transmit them.

In one embodiment, the user devices 120 may detect the presence of the ENL through the received beacons, probe responses, or FILS discovery frames and may retrieve the ENL. The user device may also obtain the ENL from nearby APs using an access network query protocol (ANQP) request/response mechanism. ANQP is a query and response protocol used by a device to discover a range of information, including a domain name, roaming information, an IP address type availability, and other metadata useful in a device's network selection process.

In one embodiment, when a user device receives the ENL, the user device may process the ENL by checking it against its policies, preferences, and profiles. When the user device receives the ENL, the user device may process the ENL by checking it against its policies, preferences, and profiles. That is, the user device may select a preferred AP or network from the ENL based on any policy, preference, or profile. For example, if a user device determines that APs with a specific SSID are preferred, the user device may select the AP with that SSID from the ENL. In another example, if the user device determines APs with specific SSIDs and predetermined distance, power measurements, signal to noise ratios (SNRs), or any other requirements, the user device may select the AP that is found in the ENL that meets these requirements.

Further, the user device may prioritize the scanning channel to select the preferred AP to connect to. When the user device selects the preferred AP, the user device may perform association with that AP. The preferred AP may be prioritized between APs within the same ESS, different ESS, same BSS or different BSS, soft AP, or Wi-Fi direct GO device. It is understood that the above descriptions are for purposes of illustration and are not meant to be limiting.

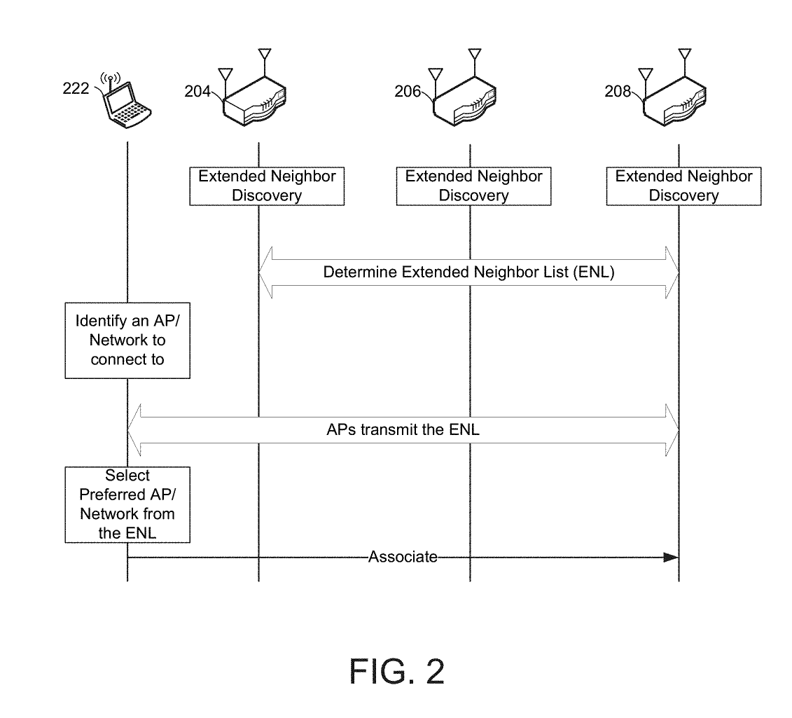

FIG. 2 depicts an illustrative diagram of an extended neighbor list and optimized AP discovery, in accordance with one or more example embodiments of the present disclosure.

Referring to FIG. 2, a user device 222 may intend to connect to one or more APs in order to access a network. In this example, the user device 222 may be in proximity to APs 204, 206, and 208.

In one embodiment, each of the APs 204, 206, and 208 may build and update their ENLs by discovering and including the Wi-Fi APs belonging to the same ESS and different ESS, single standalone APs, soft APs and Wi-Fi direct GO devices and neutral host devices in unlicensed and shared spectrum in the extended neighbor list. The discovery mechanism may include active scanning, passive scanning, out of band configuration, FILS discovery frames, ANQP queries, and other methods across all the bands and channels supported by the AP. The AP information may be included in the ENL. For example, each AP information entry in the ENL may have a TBTT information header, a short SSID, and/or an operating channel. The AP information may help the user device 222 to access the network.

In one embodiment, the ENL may be updated by each AP based on configured time periods such as 1 to 3 minutes depending on the network density and dynamics. The ENL may also include the last update time stamp. In other embodiments, the user device 222 may request an ENL (or an updated ENL) from at least one of the APs in proximity to the user device 222. In some embodiments, the user device may obtain the ENL from multiple neighboring APs and combine them and then select the best AP or wireless network to connect to. In this scenario, a user device may send a request to each of the neighboring APs. The neighboring APs may have generated an ENL list. Each of the neighboring APs may send their respective ENL list to the user device. Consequently, the user device may receive different ENL lists from different neighboring APs. The user device may then combine the different ENL lists into a single ENL list or otherwise search through the different in our lists to find the best AP to associate with.

In a pre-associated or post-associated state, when a user device tries to find an AP/network to connect to, it tries to make use of the ENL that it can obtain from the nearby APs—without going through the full scan of all bands and channels supported by the device. The user device may then use the ENL in prioritizing its target channels to scan if needed. For example, the user device 222 that receives the ENL may decode or otherwise determine from the ENL the list of nearby APs (e.g., APs 204, 206, and 208) without the need to continuously scan available channels for nearby APs.

In one embodiment, the APs may set the presence of the ENL using an indication bit included in at least one of the beacon frames, the probe responses, the FILS discovery frames, or any other frames. For example, the APs 204, 206, and 208 may set a bit (e.g., an ENL bit or any other designated bit) to 1 in a beacon frame to indicate that the ENL list exists. The APs may also indicate the location of the ENL in any of these frames. Continuing this example, one or more of the APs 204, 206, and 208 may transmit the beacon frame to the user device 222. When the user device 222 receives a beacon frame, the user device 222 may decode or otherwise determine the setting of the ENL bit to determine whether the ENL list is included or not. Since in this example the ENL bit was set to 1 in the beacon frame received by the user device 222, the user device 222 may detect the presence of the ENL. Although an ENL bit is used to indicate the presence of the ENL, other mechanisms may be used to announce the presence of the ENL to the user devices in proximity to the AP.

In another embodiment, the user device 222 may determine or otherwise detect the presence of the ENL using an ANQP request/response mechanism to obtain the ENL.

The user device 222 may make use of the ENL when it tries to find the appropriate AP/network by checking its profiles, preferences, or policies. For example, the user device 222 may have a preference to utilize a preferred network having a specific SSID. The user device 222 may compare the preference to the ENL in order to determine the appropriate AP/network based on that preference. When the user device 222 identifies the appropriate AP/network, the user device 222 may connect to that AP/network. For example, the user device 222 may determine, based on the ENL received from at least one of the APs 204, 206, or 208, and also based on its preferences or policies, that AP 208 is a preferred AP to connect to. The user device 222 may then associate or otherwise connect to the AP 208 in order to access the network.

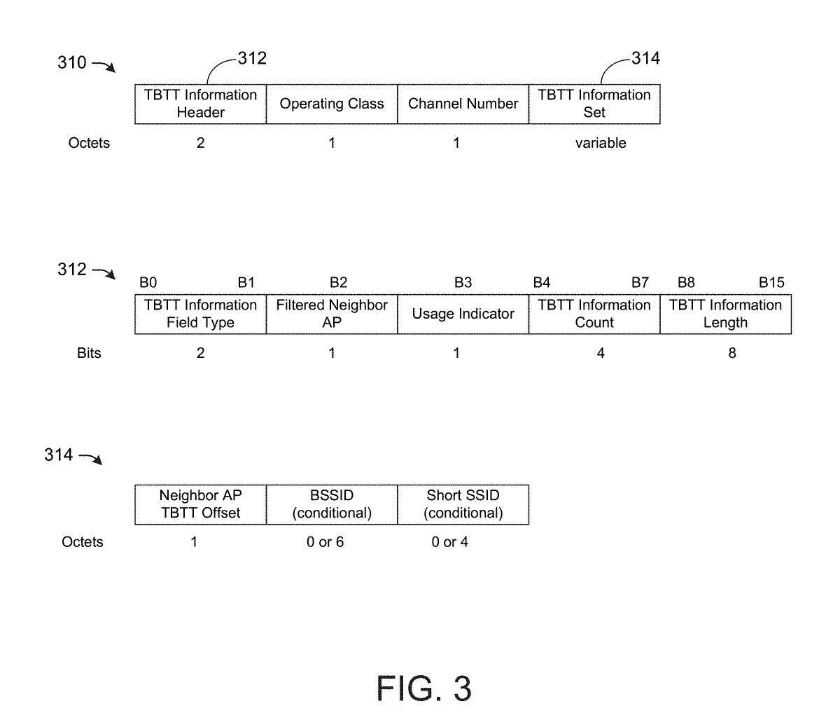

FIG. 3 depicts illustrative frame formats associated with an extended neighbor list and optimized AP discovery, in accordance with one or more example embodiments of the present disclosure.

In one embodiment, the ENL may be based at least in part on a neighbor AP information field 310. The neighbor AP information field 310 may include at least in part a TBTT information header 312, an operating class field, a channel number field, and a TBTT information set 314. The operating class field may indicate the band and bandwidth of the primary channel of the APs in the neighbor AP information field 310. The channel number field may indicate the last known primary channel of the APs in the neighbor AP information field 310.

The TBTT information header 312 may include at least in part a filtered neighbor AP subfield, which may be set to 1 or 0 in a frame based on whether the neighbor AP information field matches the specific SSID in the corresponding frame. The frame may be a probe response frame, a beacon frame, an FILS discovery frame, or any other frame capable of setting neighbor AP information.

The TBTT information set 314 may include one or more TBTT information fields that may include, at least in part, a neighbor AP TBTT offset, a BSSID, and/or a short SSID.

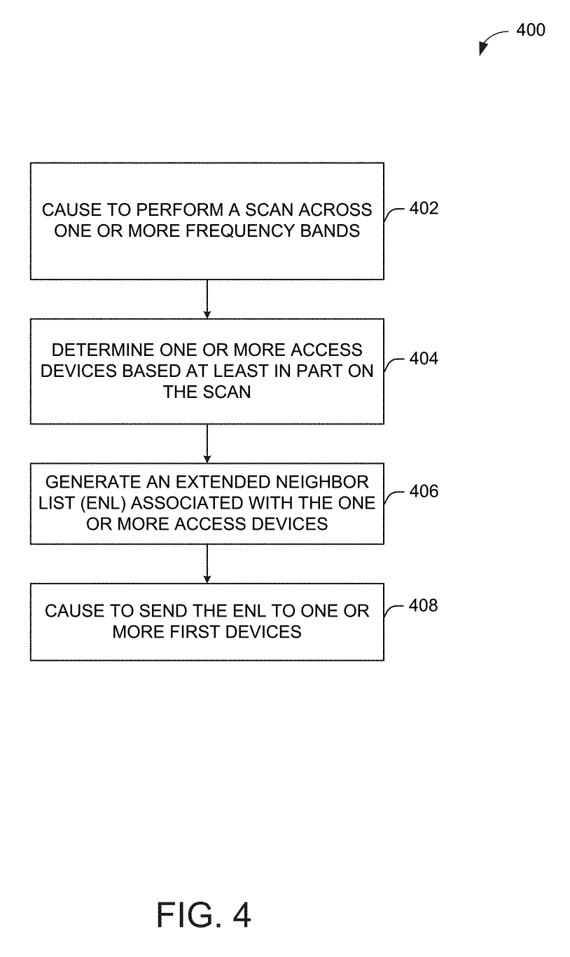

FIG. 4 illustrates a flow diagram of an illustrative process 400 at a neighboring AP for an illustrative extended neighbor list and optimized AP discovery system, in accordance with one or more example embodiments of the present disclosure.

At block 402, a device (e.g., the user device(s) 120 and/or the AP(s) 102 of FIG. 1) may cause to perform a scan across one or more frequency bands.

For example, one or more APs may periodically scan and detect all other neighbor APs across all the bands (e.g., 2.4, 3.5 GHz, 5 GHz, 60 GHz, or any other bands) and channels they support. A scan may be performed by utilizing discovery techniques, such as active scanning, passive scanning, out of band configuration, FILS discovery frames, ANQP queries and other methods across all the bands and channels supported by the one or more APs.

At block 404, the device may determine one or more access devices based at least in part on the scan. For example, a Wi-Fi AP or neutral host device may discover other neighbor APs or neutral hosts devices that may be in proximity of the AP or the neutral host. The neighbor APs may belong to different BSSs or different ESSs. That is the APs may belong to different networks having different SSIDs.

At block 406, the device may generate an extended neighbor list (ENL) associated with the one or more access devices. For example, an AP may generate the ENL by including the band, the operating channel, the short SSID, and the TBTT for each neighbor AP within the same ESS, different ESS, standalone BSS, Soft APs or Wi-Fi direct GO devices. The AP would then notify the STAs in its proximity using beacons, probe responses, FILS discovery frames, or any other mechanisms to broadcast or multicast the existence of the ENL. The indication may be in the form of a bit (e.g., an ENL bit or any other designated bit) that may be set in any of the beacons, probe responses, or FILS discovery frames to indicate the presence of the ENL. For example, if a first AP belonging to a first ESS and a second AP belonging to a second ESS, where the first ESS and the second ESS are for different networks, the ENL may include information associated with the first AP and the second AP. The ENL entries may be modified, added, or removed based on the scanning results.

At block 408, the device (e.g., a Wi-Fi AP or neutral host in unlicensed spectrum) may cause to send the ENL to one or more first devices. For example, the APs may signal the presence/availability of the ENL to nearby user devices by setting the ENL bit. The ENL may be included in beacons, probe responses, and FILS discovery frames or any other frames. The user devices that receive the beacon frames, probe responses, or FILS discovery frames may be able to determine the presence of the ENL by determining the value of the ENL bit. For example, if the ENL bit is set to 0, this may indicate that no ENL exists, and if the ENL bit is set to 1, this may indicate that the ENL exists. Although an ENL bit is used to indicate the presence of the ENL, other mechanisms may be used to announce the presence of the ENL to the user devices in proximity to the AP. Further, the ENL may be updated based on configured time periods depending on the network density or dynamics. For example, the APs may periodically repeat the above process in scanning and discovering neighbor APs regardless of which network or organization they belong to. The AP may then generate a new ENL with new APs that may have been discovered during the last scan. Further, the AP may remove entries from the ENL in case one or more neighbor APs are no longer detected during the scan. The AP may send the updated ENL to nearby user devices. In some scenarios, the user device may request an ENL (or an updated ENL) from at least one of the APs in proximity to the user device. The user device may combine ENL from multiple APs or neutral hosts to select the best AP/network. In this scenario, a user device may send a request to each of the neighboring APs. The neighboring APs may have generated an ENL list. Each of the neighboring APs may send their respective ENL list to the user device. Consequently, the user device may receive different ENL lists from different neighboring APs. The user device may then combine the different ENL lists into a single ENL list or otherwise search through the different in our lists to find the best AP to associate with.

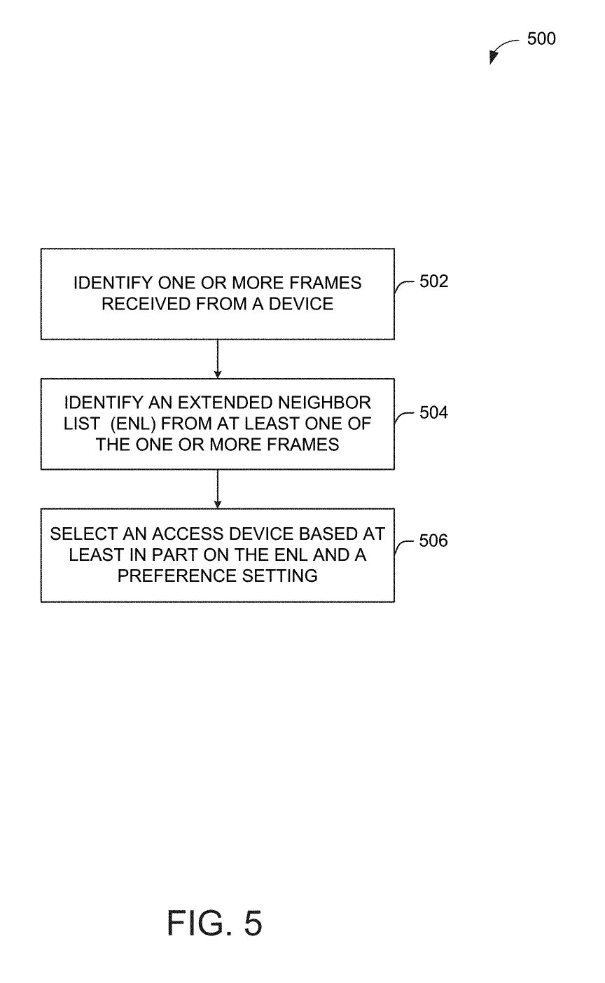

FIG. 5 illustrates a flow diagram of an illustrative process 500 for an illustrative extended neighbor list and optimized AP discovery system, in accordance with one or more example embodiments of the present disclosure.

At block 502, a device (e.g., the user device(s) 120 and/or the AP(s) 102 of FIG. 1) may identify one or more frames received from another device (e.g., the user device(s) 120 and/or the AP(s) 102 of FIG. 1). For example, a user device may be interested in connecting to at least one nearby AP. Nearby APs may have generated an ENL that contains information associated with all nearby APs, including APs belonging to a particular ESS and other APs from different ESSs, standalone APs (BSSs), soft APs, and Wi-Fi direct GO devices. For example, a user device may receive at least one of a beacon frame, a probe response frame, or FILS discovery frames or any other frames.

At block 504, the device may identify an ENL from at least one of the one or more frames. The user device may detect the presence of an ENL through the received beacons, probe responses or FILS discovery frames and may retrieve the ENL. The user device may also obtain the ENL from nearby APs using an ANQP request/response mechanism. Nearby APs may set the presence of the ENL using an indication bit included in at least one of beacon frames, probe responses, FILS discovery frames, or any other frames that may be sent to the user device. For example, nearby APs may set a bit (e.g., an ENL bit or any other designated bit) to 1 in a beacon frame to indicate that the ENL list exists. The APs may also indicate the location of the ENL in any of these frames. The ENL may include at least one of a band, an operating channel, a short SSID (or SSID), or a TBTT for each AP within the same ESS, APs belonging to different ESSs, standalone BSSs, soft APs or Wi-Fi direct GO devices. When the user device receives a beacon frame, the user device may decode or otherwise determine the setting of the ENL bit to determine whether the ENL list is included or not. If for example, the ENL bit was set to 1 in the beacon frame, the user device may detect the presence of the ENL. Although an ENL bit is used to indicate the presence of the ENL, other mechanisms may be used to announce the presence of the ENL to the user devices in proximity to the AP. The user device may then obtain the ENL from the beacon frame or from any other frame that may contain the ENL.

At block 506, the device may select an access device based at least in part on the ENL and a preference setting. For example, when the user device receives the ENL, the user device may process the ENL by checking it against its policies, preferences, and profiles. That is, the user device may select a preferred AP or network from the ENL based on any policy, preference or profile. For example, if a user device determines that the APs with a specific SSID are preferred, the user device may select the AP with that SSID from the ENL. In another example, if the user device determines APs with specific SSIDs and predetermined distance, power measurements, signal to noise ratios (SNRs), or any other requirements, the user device may select the AP that is found in the ENL that meets these requirements.

Further, the user device may prioritize the scanning channel to select the preferred AP to connect to. When the user device selects the preferred AP, the user device may perform association with that AP. The right AP may be prioritized between APs within the same ESS, different ESS, same BSS or different BSS, soft AP, or Wi-Fi direct GO device. It is understood that the above descriptions are for purposes of illustration and are not meant to be limiting and it is applicable to neutral host devices in unlicensed, shared spectrum and other bands.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, neutral hosts, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 1-5.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, up conversion/down conversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field- programmable gate arrays (FPGAs), application specific integrated circuits (ASICs), radio- frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), an extended neighbor list and optimized AP discovery device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The extended neighbor list and optimized AP discovery device 719 may carry out or perform any of the operations and processes (e.g., the processes 400 and 500) described and shown above. For example, the extended neighbor list and optimized AP discovery device 719 may be configured to enable providing a complete list of APs across all the bands and channels in the neighborhood of APs so that STAs can make use of such information when prioritizing their channels for scanning and helping with fast discovery and association with the right AP/network.

The extended neighbor list and optimized AP discovery device 719 may facilitate mobile devices to quickly find the right APs and/or networks to connect to. The benefits may be reduced power consumption, reduced delay, and minimized airspace thrashing due to the increased number of probe requests and response messages.

The extended neighbor list and optimized AP discovery device 719 may enable APs and neutral hosts to scan all the bands (e.g., 2.4, 3.5 GHz, 5 GHz, 60 GHz, and any other future bands) they support and all channels within the bands regardless of whether the APs belong to the same ESS or not.

The extended neighbor list and optimized AP discovery device 719 may build an extended neighbor list (ENL) of all APs and neutral hosts—including the APs belonging to particular ESSs and the other APs from different ESSs, standalone APs (BSSs), soft APs and Wi-Fi direct GO devices.

The extended neighbor list and optimized AP discovery device 719 may enable an AP to indicate the presence of the ENL and transmit it to the nearby mobile devices (STAs). These STAs may receive the ENL in order to minimize having to continuously scan available frequency bands in order to find APs to connect to.

The extended neighbor list and optimized AP discovery device 719 may enable the STAs to use the ENL to prioritize scanning of the channels and APs quickly and to associate with the correct AP/network without going through a full scan of bands and channels.

It is understood that the above are only a subset of what the extended neighbor list and optimized AP discovery device 719 may be configured to perform and that other functions included throughout this disclosure may also be performed by the extended neighbor list and optimized AP discovery device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others and other technologies operating in unlicensed, shared and other bands. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 400 and 500) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed wireless Access Point or a neutral host, small cell, or soft AP, Wi-Fi Direct GO mobile station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions. The device may further include instructions to at least one processor configured to access the at least one memory, wherein the at least one processor is configured to execute the computer-executable instructions to cause to perform a scan across one or more frequency bands. The device may further include instructions to determine one or more access devices based at least in part on the scan. The device may further include instructions to generate an extended neighbor list (ENL) associated with the one or more access devices. The device may further include instructions to cause to send the ENL to one or more first devices.

The implementations may include one or more of the following features. The ENL may include at least one of a frequency band, an operating channel, a service set identifier, or a target beacon transmission time. The one or more access devices include at least one of an access point, a neutral host, a software AP, or a Wi-Fi direct group owner device. The one or more access devices belong to a same extended service set. At least one of the one or more access devices belongs to a different extended service set. The at least one processor may be further configured to execute the computer-executable instructions to set an ENL bit in one or more frames. The one or more frames include at least in part a beacon frame, a probe response frame, or a fast initial link set up discovery frame. The scan is at least one of a passive scan, an active scan, an access network query protocol, or an out of band configuration scan. The device may further include a transceiver configured to transmit and receive wireless signals. The device may further include one or more antennas coupled to the transceiver.

According to example embodiments of the disclosure, there may be a device. The device may include at least one memory that stores computer-executable instructions. The device may further include instructions to at least one processor configured to access the at least one memory, wherein the at least one processor is configured to execute the computer-executable instructions to identify one or more frames received from a device. The device may further include instructions to identify an extended neighbor list (ENL) from at least one of the one or more frames. The device may further include instructions to select an access device based at least in part on the ENL or a combination of ENLs from multiple devices and a preference setting.

The implementations may include one or more of the following features. The ENL may include at least one of a frequency band, an operating channel, a service set identifier, or a target beacon transmission time. The access device is at least one of an access point, a neutral host, a software AP, or a Wi-Fi direct group owner device. The device may further include instructions to identify one or more user preferences associated with selecting the access device. The one or more frames include at least in part, a beacon frame, a probe response frame, or a fast initial link set up discovery frame.

According to example embodiments of the disclosure, there may be a non-transitory computer-readable medium storing computer-executable instructions which, when executed by a processor, cause the processor to perform operations. The operations may include identifying one or more frames received from a device. The operations may include identifying an extended neighbor list (ENL) from at least one of the one or more frames. The operations may include selecting an access device based at least in part on the ENL or a combination of ENLs from multiple devices and a preference setting.

The implementations may include one or more of the following features. The ENL may include at least one of a frequency band, an operating channel, a service set identifier, or a target beacon transmission time. The access device is at least one of an access point, a neutral host, a software AP, or a Wi-Fi direct group owner device. The computer-executable instructions cause the processor to further perform operations comprising identifying one or more user preferences associated with selecting the access device. The one or more frames include at least in part, a beacon frame, a probe response frame, or a fast initial link set up discovery frame.

According to example embodiments of the disclosure, there may be a non-transitory computer-readable medium storing computer-executable instructions which, when executed by a processor, cause the processor to perform operations. The operations may include causing to perform a scan, by one or more processors, across one or more frequency bands. The operations may include determining one or more access devices based at least in part on the scan. The operations may include generating an extended neighbor list (ENL) associated with the one or more access devices. The operations may include causing to send the ENL to one or more first devices.

The implementations may include one or more of the following features. The ENL may include at least one of a frequency band, an operating channel, a service set identifier, or a target beacon transmission time. The one or more access devices include at least one of an access point, a neutral host, a software AP, or a Wi-Fi direct group owner device. The one or more access devices belong to a same extended service set. At least one of the one or more access devices belongs to a different extended service set. The computer-executable instructions cause the processor to further perform operations comprising setting an ENL bit in one or more frames. The one or more frames include at least in part a beacon frame, a probe response frame, or a fast initial link set up discovery frame. The scan is at least one of a passive scan, an active scan, an access network query protocol, or an out of band configuration scan.

According to example embodiments of the disclosure, there may include a method. The method may include causing to perform a scan, by one or more processors, across one or more frequency bands. The method may include determining one or more access devices based at least in part on the scan. The method may include generating an extended neighbor list (ENL) associated with the one or more access devices. The method may include causing to send the ENL to one or more first devices.

The implementations may include one or more of the following features. The ENL includes at least one of a frequency band, an operating channel, a service set identifier, or a target beacon transmission time. The one or more access devices include at least one of an access point, a neutral host, a software AP, or a Wi-Fi direct group owner device. The one or more access devices belong to a same extended service set. At least one of the one or more access devices belongs to a different extended service set. The method may further include setting an ENL bit in one or more frames. The one or more frames include at least in part a beacon frame, a probe response frame, or a fast initial link set up discovery frame. The scan is at least one of a passive scan, an active scan, an access network query protocol, or an out of band configuration scan.

According to example embodiments of the disclosure, there may include a method. The method may include identifying one or more frames received from a device. The method may include identifying an extended neighbor list (ENL) from at least one of the one or more frames. The method may include selecting an access device based at least in part on the ENL or a combination of ENLs from multiple devices and a preference setting.

The implementations may include one or more of the following features. The ENL includes at least one of a frequency band, an operating channel, a service set identifier, or a target beacon transmission time. The access device is at least one of an access point, a neutral host, a software AP, or a Wi-Fi direct group owner device. The method may further include identifying one or more user preferences associated with selecting the access device. The one or more frames include at least in part, a beacon frame, a probe response frame, or a fast initial link set up discovery frame.

In example embodiments of the disclosure, there may be an apparatus. The apparatus may include means for causing to perform a scan, by one or more processors, across one or more frequency bands. The apparatus may include means for determining one or more access devices based at least in part on the scan. The apparatus may include means for generating an extended neighbor list (ENL) associated with the one or more access devices. The apparatus may include means for causing to send the ENL to one or more first devices.

The implementations may include one or more of the following features. The ENL includes at least one of a frequency band, an operating channel, a service set identifier, or a target beacon transmission time. The one or more access devices include at least one of an access point, a neutral host, a software AP, or a Wi-Fi direct group owner device. The one or more access devices belong to a same extended service set. At least one of the one or more access devices belongs to a different extended service set. The apparatus may further include means for setting an ENL bit in one or more frames. The one or more frames include at least in part a beacon frame, a probe response frame, or a fast initial link set up discovery frame. The scan is at least one of a passive scan, an active scan, an access network query protocol, or an out of band configuration scan.

In example embodiments of the disclosure, there may be an apparatus. The apparatus may include means for identifying one or more frames received from a device. The apparatus may include means for identifying an extended neighbor list (ENL) from at least one of the one or more frames. The apparatus may include means for selecting an access device based at least in part on the ENL or a combination of ENLs from multiple devices and a preference setting. The implementations may include one or more of the following features. The ENL includes at least one of a frequency band, an operating channel, a service set identifier, or a target beacon transmission time. The access device is at least one of an access point, a neutral host, a software AP, or a Wi-Fi direct group owner device. The apparatus may further include means for identifying one or more user preferences associated with selecting the access device. The one or more frames include at least in part, a beacon frame, a probe response frame, or a fast initial link set up discovery frame.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising:
at least one memory that stores computer-executable instructions; and
at least one processor configured to access the at least one memory, wherein the at least one processor is configured to execute the computer-executable instructions to:
cause to perform a scan across one or more frequency bands;
determine one or more access devices based at least in part on the scan;
generate an extended neighbor list (ENL) associated with the one or more access devices; and
cause to send the ENL to one or more first devices.

2. The device of claim 1, wherein the ENL includes one of a frequency band, an operating channel, a service set identifier, or a target beacon transmission time.

3. The device of claim 1, wherein the one or more access devices include at least one of an access point, a neutral host, a software AP, or a Wi-Fi direct group owner device.

4. The device of claim 1, wherein the one or more access devices belong to a same extended service set.

5. The device of claim 1, wherein the one or more access devices belong to a different extended service set.

6. The device of claim 1, wherein the at least one processor is further configured to execute the computer-executable instructions to set an ENL bit in one or more frames.

7. The device of claim 6, wherein the one or more frames include at least in part, a beacon frame, a probe response frame, or a fast initial link set up (FILS) discovery frame.

8. The device of claim 1, wherein the scan is at least one of a passive scan, an active scan, an access network query protocol (ANQP), or an out of band configuration scan.

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
identifying one or more frames received from a device;
identifying an extended neighbor list (ENL) from at least one of the one or more frames; and
selecting an access device based at least in part on the ENL or a combination of ENLs from multiple APs and a preference setting.

12. The non-transitory computer-readable medium of claim 11, wherein the ENL includes at least in part a frequency band, an operating channel, a service set identifier (SSID), or a target beacon transmission time (TBTT).

13. The non-transitory computer-readable medium of claim 12, wherein the access device is at least one of an access point, a software AP, a neutral host, or a Wi-Fi direct group owner device.

14. The non-transitory computer-readable medium of claim 11, wherein the computer-executable instructions cause the processor to further perform operations comprising identifying one or more user preferences associated with selecting the access device.

15. The non-transitory computer-readable medium of claim 11, wherein the one or more frames include at least in part, a beacon frame, a probe response frame, or a fast initial link set up discovery frame.

16. A method comprising:
causing to perform a scan, by one or more processors, across one or more frequency bands;
determining one or more access devices based at least in part on the scan;
generating an extended neighbor list (ENL) associated with the one or more access devices; and
causing to send the ENL to one or more first devices.

17. The method of claim 16, wherein the ENL includes at least in part a frequency band, an operating channel, a service set identifier, or a target beacon transmission time.

18. The method of claim 16, wherein the one or more access devices include at least one of an access point, a software AP, a neutral host, or a Wi-Fi direct group owner device.

19. The method of claim 16, wherein the one or more access devices belong to a same extended service set.

20. The method of claim 16, wherein at least one of the one or more access devices belong to a different extended service set.
